(19) United States
(12) Patent Application Publication
(10) Pub. No.: US 2016/0231548 A1
(43) Pub. Date: Aug. 11, 2016

(54) COMPACT MICROSCOPE APPARATUS AND METHOD OF USE

(71) Applicants: Chandran Sabanayagam, Camden-Wyoming, DE (US); Aroshan Jayasinghe, Newark, DE (US)

(72) Inventors: Chandran Sabanayagam, Camden-Wyoming, DE (US); Aroshan Jayasinghe, Newark, DE (US)

(73) Assignee: University of Delaware, Newark, DE (US)

(21) Appl. No.: 15/014,264

(22) Filed: Feb. 3, 2016

Related U.S. Application Data
(60) Provisional application No. 62/113,679, filed on Feb. 9, 2015.

(51) Int. Cl. G02B 21/00; G02B 21/24; G02B 21/02; G02B 21/36; G02B 21/26; G02B 21/06

(52) U.S. Cl. CPC G02B 21/0008; G02B 21/26; G02B 21/06; G02B 21/02; G02B 21/361; G02B 21/248; G02B 21/362; G02B 21/16

(57) ABSTRACT

Compact microscope apparatus and methods of use are disclosed. One apparatus includes a stage, a light source, an objective, a dichroic element, and an imaging sensor. The stage is configured to hold a sample thereon. The light source is configured to emit light toward the stage. The objective is positioned to focus light from the stage. The dichroic element is configured to pass or reflect respective ones of the light emitted by the light source and the light from the stage. The imaging sensor is positioned to receive the light from the stage. The stage, the light source, the objective, the dichroic element, and the imaging sensor are arranged such that they may be received within an enclosure having dimensions no longer than about 300 mm. The apparatus may include a clinostat operable to continuously rotate the components of the apparatus about an axis.

### CROSS-REFERENCE TO RELATED APPLICATIONS

This application claims the benefit of U.S. Pat. No. 62,113,679, filed Feb. 9, 2015, entitled “COMPACT MICROSCOPE APPARATUS AND METHOD OF USE,” the contents of which are incorporated herein by reference in their entirety.

### FIELD OF THE INVENTION

The present invention relates generally to microscopy, and more particularly, to compact microscopes suitable for use in moving or space applications.

### BACKGROUND OF THE INVENTION

Conventional microscopes incorporate large, bulky components. They may be table-top apparatus with external, unattached power sources or control devices. Additionally, conventional microscopes require a stable-unmoving base on which the sample can be positioned in order to obtain a clear, focused microscopic image.

Recently, there has been growing interest in the number and diversity of scientific measurements and experiments that may be performed in zero gravity or near-zero gravity environments, such as low earth orbit. Because of the cost and difficulty involved in launching crafts into orbit, any experimental equipment on such crafts is desirably small and lightweight. In view of the above, improved microscope apparatus for use in space and other moving applications are desired.

### SUMMARY OF THE INVENTION

Aspects of the present invention are directed to compact microscope apparatus and methods of use.

In accordance with one aspect of the present invention, a compact microscope apparatus is disclosed. The apparatus includes a stage, a light source, an objective, a dichroic element, and an imaging sensor. The stage is configured to hold a sample thereon. The light source is configured to emit light toward the stage. The objective is positioned to focus light from the stage. The dichroic element is configured to pass one of the light emitted by the light source and the light from the stage and reflect the other one of the light emitted by the light source and the light from the stage. The imaging sensor is positioned to receive the light from the stage. The stage, the light source, the objective, the dichroic element, and the imaging sensor are arranged such that they may be received within an enclosure having dimensions no longer than about 300 mm.

In accordance with another aspect of the present invention, another compact microscope apparatus is disclosed. The apparatus includes a stage, a light source, an objective, a dichroic element, an imaging sensor, and a clinostat. The stage is configured to hold a sample thereon. The light source is configured to emit light toward the stage. The objective is positioned to focus light from the stage. The dichroic element is configured to pass one of the light emitted by the light source and the light from the stage and reflect the other one of the light emitted by the light source and the light from the stage. The imaging sensor is positioned to receive the light from the stage. The clinostat, to which the stage, the light source, the objective, the dichroic element, and the imaging sensor are attached, is operable to continuously rotate the stage, the light source, the objective, the dichroic element, and the imaging sensor about an axis.

In accordance with yet aspect of the present invention, a method for obtaining a microscopic image of a sample is disclosed. The method includes the steps of rotating a microscope with a clinostat, and obtaining an image of the sample with the microscope while the microscope is rotated with the clinostat.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIGS. 1A is a diagram schematically illustrating a layout of an optical subsystem of an exemplary compact microscope apparatus in accordance with aspects of the present invention;

FIG. 1B is a diagram illustrating a side view of the compact microscope apparatus of FIG. 1A

FIG. 2 is a block diagram illustrating an exemplary control structure for the compact microscope apparatus of FIG. 1A;

FIG. 3 is a diagram illustrating an enclosure of the compact microscope apparatus of FIG. 1A;

FIGS. 4A-4C are diagrams illustrating alternative exemplary layouts of the compact microscope apparatus of FIG. 1A;

FIG. 5 is an image illustrating another exemplary compact microscope apparatus in accordance with aspects of the present invention; and

FIG. 6 is a flowchart illustrating an exemplary method for obtaining a microscopic image in accordance with aspects of the present invention.

### DETAILED DESCRIPTION OF THE INVENTION

The apparatus and methods described herein are directed to compact microscopes that may be used in any application in which a small, lightweight, and/or hermetically-sealed microscope is desired. These exemplary embodiments are described herein principally with respect to fluorescence microscopes. However, it will be understood by one of ordinary skill in the art that the apparatus and methods disclosed herein are usable with any type of microscope known to one of ordinary skill in the art, and are not limited to fluorescence microscopes. Other suitable types of microscopes include, by way of example, wide-field, scattering, phase contrast, dark field and polarization microscopes.

The exemplary apparatus and methods disclosed herein may be particularly suitable for enabling microscopy in zero gravity or microgravity environment, such as in orbit. Due to the compact size and low weight of the disclosed microscopes, they are well-suited for use in satellites or other spacecraft where payload weight and size are critical. These disclosed embodiments may enabled the novel testing of microscopic objects in diminished gravity. Likewise, the disclosed embodiments may be useful in any situation where an easily portable microscope may be desired.

Conventional microscopes are generally classified as “upright” (i.e. objective facing down on the sample) or “inverted” (objective is below the sample). Inverted microscopes may be used for imaging in liquids because the scope images through the coverslip and into the liquid; conversely, upright microscopes may be more desirable for certain applications of microscopy through air. Due to their small size, the disclosed microscopes may be operated in either upright or inverted configurations (or any other arbitrary configuration), making them preferable to the conventional models that are limited to one or the other.

The following description relates generally to compact, portable, high-resolution fluorescence microscopes. The microscope apparatus may be battery operated, and can include computers and cameras. Conventional microscopes are typically stationary, and placed on a stable platform. By contrast, the disclosed embodiments enable use of a compact microscope in applications that require micrographs be obtained while in motion. For example, for a microscope housed in a satellite, the satellite moves about 15,000 miles per hour. Another example is a clinostat microscope that rotates between slightly greater than 0 revolutions per minute (rpm), to over 100 rpm. In a satellite platform, the microscope may be sealed in a hermetic enclosure. Alternatively, the hermetic enclosure may be used in ground-based applications (e.g., where different pressures or gas concentrations (H₂, N₂, CO₂, O₂) are used).

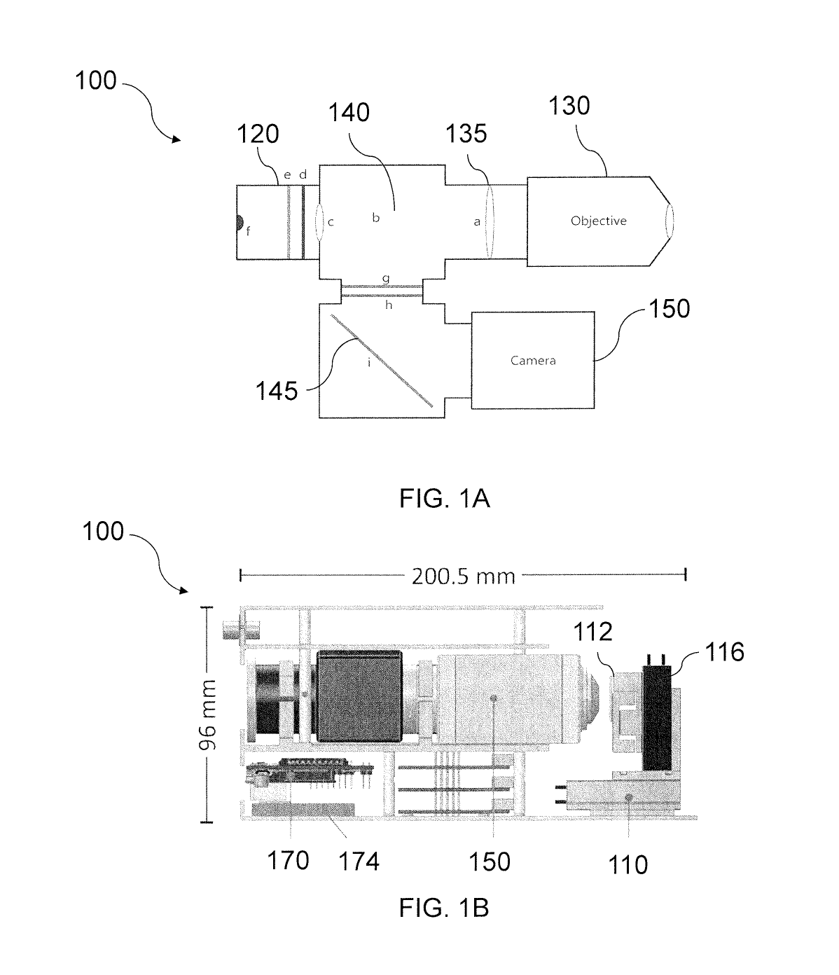

With reference to the drawings, FIGS. 1A and 18 illustrate an exemplary compact microscope apparatus 100 in accordance with aspects of the present invention. Apparatus 100 may be a fluorescence microscope usable to obtain microscopic images in low gravity or moving environments. In general, apparatus 100 includes a stage 110, a light source 120, an objective 130, a dichroic element 140, and an imaging sensor 150. Additional details of apparatus 100 are described below.

Stage 110 is configured to hold a sample thereon. Stage 110 includes a front surface 112 facing objective 130 on which the sample can be mounted. In an exemplary embodiment, stage 110 includes one or more magnets for securing the sample on front surface 112. The magnets on stage 110 may be positioned to mate with corresponding magnets on a separate plate, such as an aluminum plate. The sample may be provided on the separate plate, or the plate may secure the sample to stage 110 by pressing the sample between the plate and surface 112. In an alternative embodiment, stage 110 includes one or more attachment structures for securing the sample to stage 110. Suitable attachment structures will be known to one of ordinary skill in the art, and include, by way of example, clips or clamps.

Stage 110 is movable relative to the other components of apparatus 100. In particular, stage 110 may be movable in a direction along the viewing axis of apparatus 100, in order to change a distance travelled by light from stage 110 to imaging sensor 150. In other words, stage 110 is movable to change the focal distance of apparatus 100.

Stage 110 may also include a fluorescent background portion positioned behind the area to which the sample is mounted. The background portion enables microscopic imaging of non-fluorescent samples by effectively back-lighting the samples, creating a pseudo-bright-field image. Suitable background portions include, for example, autofluorescent slides provided by Chroma Technologies Corp., of Bellows Falls, Vt.

In an exemplary embodiment, stage 110 includes three piezoelectric-motor driven linear translation stages 116 to form a three-axis sample stage. Each linear translation stage 116 has an integrated linear encoder and approximately 27 mm of travel. Accordingly, stage 110 provides a maximum scan volume of 27×27×14 mm, with a desired minimum step size of about 200 nm. Suitable linear translation stages 116 for use with stage 110 include, by way of example, the Conex-AG-LS25-27P provided by Newport Co. of Irvine, Calif.

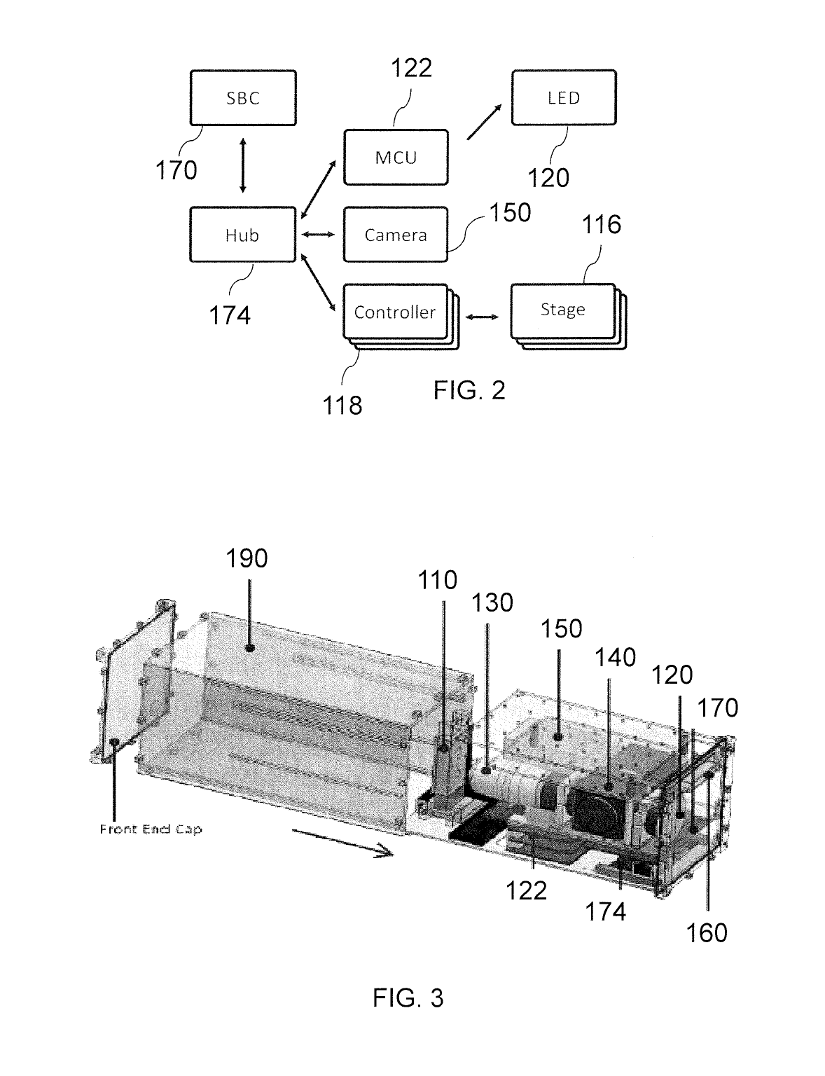

Each linear translation stage 116 has an associated driver 118 (shown as “controller” in FIG. 2). In an exemplary embodiment, three compact, USB-connected, low-power drivers 118 respectively control the three stages. Each driver may use a serial-via-USB interface to communicate with a computing element 170 for controlling the positioning of stage 110, as will be discussed below.

Light source 120 is configured to emit light toward stage 110. Light source 120 is selected to emit light at an appropriate excitation wavelength for inducing fluorescence in a sample attached to stage 110. Alternatively or additionally, light source 120 may be selected to emit light at an appropriate excitation wavelength for inducing fluorescence in the background portion of stage 110 in order to obtain a backlit image of the sample. In an exemplary embodiment, light source 120 is a blue light emitting diode (LED) having a wavelength of around 470 nm. In this embodiment, light source 120 may include a focusing lens, diffuser, and color filter or polarizer, as schematically shown by elements c, d, and e in FIG. 1A. Suitable components for the above structures will be known to one of ordinary skill in the art from the description herein. Other suitable light sources for use as light source 120 will be known to one of ordinary skill in the art from the description herein.

In an exemplary embodiment, a microcontroller 122 (shown in FIG. 2) may be provided to generate a pulse-width-modulated signal for controlling light source 120. As will be discussed below, microcontroller 122 may be connected to computing element 170 for controlling illumination of the sample with the light source 120. Suitable microcontrollers for use with light source 120 include, for example, the Arduino Nano provided by Arduino.

Objective 130 is positioned to focus light from stage 110. Objective 130 includes one or more lenses therein to collect and magnify the light from the sample on stage 110, and transmit that light toward imaging sensor 150. Suitable objectives for use as objective 130 will be known to one of ordinary skill in the art from the description herein. For example, suitable objectives may be CFI S Plan Fluor ELWD series objectives provided by Nikon Instruments Inc., of Melville, N.Y. The magnification of the objective may be selected based on the desired imaging resolution. Exemplary suitable magnifications for the objectives of the present invention have a magnification of between 1x and 50x, but are not limited thereto.

In an exemplary embodiment, objective 130 is not movable relative to the other components of apparatus 100. Objective 130 may instead be fixed in position relative to image sensor 150, in order to prevent movement in a direction along the viewing axis of apparatus 100. In this embodiment, stage 110, and not objective 130, is moved in order to change a distance travelled by light from stage 110 to imaging sensor 150.

Apparatus 100 may also include an additional lens 135 positioned between objective 130 and dichroic element 140, as shown in FIG. 1A. In an exemplary embodiment, lens 135 is an achromatic lens positioned to act as a tube lens for the microscope. Lens 135 helps focus the excitation light from light source 120 onto the back aperture of objective 130. Given the space constraints for apparatus 100, the focal length of lens 135 may be shorter than that nominally required by the objective 130. Accordingly, the total magnification of the microscope may be modified by a factor of the nominal magnification of objective 130 multiplied by the focal length of lens 135 divided by the normal tube lens focal length: Mag=(Nom. Obj. Mag.)×(Lens 135)/(Nom. Tube lens). Generally, the higher the numerical aperture (NA), the higher the resolution. Accordingly, using a 60x objective with a shorter-than-design tube lens can offer higher resolution than using an equivalent 20x objective with a lower NA compared to the 60x (e.g. 20X NA .45 objective with nominal 200 mm focal length tube lens will be LOWER resolution than using a 60X NA .75 objective with a 66.6 mm tube lens (mag=20x)).

In an exemplary embodiment, objective 130 has a focal length of 200 mm, and lens 135 has a focal length of 125 mm. In apparatus 100, the focal length of lens 135 is less than that specified for use with most commercial objectives. As a result, the effective magnification this microscope is less than the nominal magnification stamped on the objective (e.g., 12x effective magnification for a 20x objective).

Dichroic element 140 redirects light within apparatus 100. Dichroic element 140 is positioned with the path of the light from light source 120 and the light from stage 110 collected by objective 130. Dichroic element 140 is a dichroic mirror configured to reflect light falling within a first wavelength band and to allow light falling within a second different wavelength band to be transmitted therethrough. Dichroic element 140 may have a reflective coating formed on one side thereof, in order to assist in reflecting incoming light received from one direction, and transmit incoming light from an opposite direction.

In an exemplary embodiment, dichroic element 140 is designed to allow light from light source 120 to pass therethrough, and to reflect light from stage 110 toward imaging sensor 150. This configuration may be desirable in order to minimize the size of apparatus 100, as will be discussed below. Alternatively, dichroic element 140 may be designed to allow light from stage 110 to pass therethrough, and to reflect light from light source 120. In an exemplary embodiment, dichroic element 140 is a dichroic mirror provided by Chroma Technologies Corp, of Bellows Falls, Vt. This dichroic mirror may be configured to transmit light in a wavelength band of 400 to 490 nm and to reflect light in a wavelength band of 500 to 830 nm.

Apparatus 100 may also include one or more additional mirrors 145 for redirecting the light from dichroic element 140 toward the imaging sensor 150. Likewise, apparatus 100 may include an aperture and a color filter between dichroic element 140 and mirror 145, as schematically shown as elements g and h in FIG. 1A.

Imaging sensor 150 is positioned to receive light from stage 110 redirected by dichroic element 140. Imaging sensor 150 is configured to record an image of the sample on stage 110. In an exemplary embodiment, imaging sensor 150 is a charge-coupled device (CCD) image sensor. Suitable CCD image sensors for use as imaging sensor 150 include, for example, the PCO.Pixelfly USB, provided by PCO AG, Kelheim, Germany. Other suitable image sensors will be known to one of ordinary skill in the art from the description herein, and may include CMOS image sensors.

The above-recited components of microscope apparatus 100 are selected and arranged in such a manner to provide a compact total package for the apparatus 100. The arrangement of the components of apparatus 100 may be selected based on the space or volume requirements of the particular application in which apparatus 100 will be used.

In an exemplary embodiment, apparatus 100 may be designated for use as a microscope on a satellite or other spacecraft. In this embodiment, the components of apparatus 100 are arranged such that they will fit within an enclosure having dimensions no longer than about 300 mm (e.g., a cube having 300 mm edges). Preferably, the components of apparatus 100 are arranged such that they will fit within an enclosure having dimensions no longer than about 300 mm by about 100 mm by about 100 mm. Even more preferably, the components of apparatus 100 are arranged such that they will fit within an enclosure having dimensions of about 200 mm by about 100 mm by about 100 mm. An exemplary arrangement of the components of apparatus 100 is shown in FIGS. 1A and 1B.

The above-described dimensions may be particularly desirable for utilization of the disclosed microscope apparatus in pre-existing compartments of conventional miniaturized satellites known as CubeSat satellites. CubeSat satellites typically have cubical compartments measuring 100 mm on a side, and may be coupled together to create longer compartments along a single dimension (e.g., 200×100×100, 300×100×100, etc.). An apparatus fitting within an enclosure having dimensions of about 200 mm by about 100 mm by about 100 mm may be usable in a “2U” CubeSat, or a “3U” CubeSat if external components are required.

In any enclosure, it may be necessary for the components to be sufficiently smaller to provide space for the walls of the enclosure. In an exemplary embodiment, the enclosure will have walls having a thickness of about 3 mm, meaning that for an enclosure 100 mm wide, the components of the microscope may have a corresponding dimension of no more than about 94 mm.

It will be understood that the above-described dimensions for apparatus 100 are provided in view of the exemplary application recited above, and are not intended to be limiting. Alternative dimensions or shapes for the arrangement of components of apparatus 100 will be apparent to one of ordinary skill in the art from the description herein and the intended use of apparatus 100.

Additionally, the above-recited components of microscope apparatus 100 are selected to provide a lightweight total apparatus 100. In an exemplary embodiment, apparatus 100 has a mass of no more than 5 kg. Preferably, apparatus 100 has a mass of about 2.5 kg without its associated enclosure, and a mass of about 4.5 kg with an associated aluminum hermetic enclosure. It is desirable that apparatus have such a mass to ensure that it suitable for use in applications requiring an easily portable or movable microscope. Likewise, it is desirable that apparatus 100 have relatively low power requirements, to ensure that it can be operated in orbital environments where power availability may be limited. In an exemplary embodiment, apparatus 100 has an average power consumption of less than approximately 60 J per image obtained by imaging sensor 150 (or less than approximately 0.02 Whr). This energy may be utilized to move the stage 110 a predetermined distance (e.g., 1 mm), turn on light source 120, acquire an image with imaging sensor 150, turn off light source 120, compress the image using an onboard computing element, and store the image. To this end, exemplary components having low power consumption are disclosed herein, and will otherwise be known to one of ordinary skill in the art from the description herein.

Apparatus 100 is not limited to the above-described components, but may include alternative or additional components, as would be understood by one of ordinary skill in the art in view of the description herein.

For example, apparatus 100 may include a power supply. The power supply is coupled to provide power to the components of apparatus 100, including light source 120 and imaging sensor 150. In an exemplary embodiment, the power source is an on-board battery, such as a conventional 12 volt battery. Alternatively, apparatus 100 may include a connector 160 for attachment to an external power source. In such an embodiment, apparatus 100 may include an adaptor for adapting the power from the external power source (e.g., AC power) to a desired form for use by the components of apparatus 100. It may be preferable that apparatus 100 include an on-board power source in order to achieve the desired portability of apparatus 100.

For another example, apparatus 100 may include a computing element 170. Computing element 170 may be coupled to light source 120 and/or imaging sensor 150. Computing element 170 may be operable to provide instructions for turning light source 120 on or off. Computing element 170 may also be operable to provide instructions to imaging sensor 150 to obtain images of the sample when the sample is held on stage 110. In an exemplary embodiment, computing element 170 is a Raspberry Pi Model B single-board-computer provided by the Raspberry Pi Foundation, Caldecote, Cambridgeshire, UK. Other suitable computing elements will be known to one of ordinary skill in the art from the description herein.

In order to achieve the desired low power consumption of apparatus 100, computing element 170 can be placed in a low power standby state for brief intervals. For example, where data collection is infrequent (e.g., 1-10 data sets per 24 hr), the whole electronic system of apparatus 100 can be shut down, and rebooted at predefined intervals via an onboard real-time clock.

Computing element 170 may also be configured to communicate with devices external to apparatus 100. Communication with external devices may be desirable to allow apparatus 100 to be operated from a remote location, or to allow remote viewing and storage of the images obtained by apparatus 100. Such communication may be wired communication or wireless communication. In one embodiment, computing element 170 is in communication with at least one connector 160. Connector 160 may enable serial or parallel communication with an external computer when a wire is connected thereto. In an alternative embodiment, computing element 170 includes one or more wireless transceivers for enabling wireless communication with an external computer. For example, a Bluetooth transceiver may be used to create a wireless connection to a nearby smartphone or computer, or an IEEE 802.11 compliant wireless transceiver may be used to connect computing element 170 to a local area network. Either may allow data and command transfer between the computing element 170 and a remote computer.

For yet another example, apparatus 100 may include a memory device. The memory device may be coupled to computing element 170 and imaging sensor 150, such that computing element is operable to provide instructions for the memory device to store the images of the sample obtained by imaging sensor 150. Computing element 170 is desirably capable of acquiring, compressing, and storing a 16-bit, 1392×1040 pixel image to the memory device at a rate of at least approximately 0.5 frames per second. Preferably, computing element 170 is operable to acquire, compress, and store images at rates up to 60 fps, depending on the design and speed of computing element 170. In an exemplary embodiment, the memory device is a conventional memory card, such as a Secured Digital (SD) non-volatile memory card. Other suitable memory devices will be known to one of ordinary skill in the art from the description herein.

Where apparatus 100 includes any of the additional components recited above, or any other additional components, it will be understood that these additional components must also be arranged to achieve the spatial requirements determined for the application of apparatus 100. In other words, the power source, computing element 170, and the memory device, when present, must also be arranged to fit within the same dimensions as the remaining components of apparatus 100.

FIG. 2 illustrates an exemplary control structure for microscope apparatus 100. In an exemplary embodiment, computing element 170 is coupled to the components of apparatus 100 by way of a conventional USB hub 174. USB hub 174 provides connections between computing element 170 and the stage drivers 118, the light source microcontroller 122, and imaging sensor 150. USB hub may also include connections for providing power to the components of apparatus 100 such as light source 120 and imaging sensor 150. Computing element 170 may thereby communicate with these components via USB communications protocol. Computing element 170 may thereby instruct drivers 118 to adjust the position of stage 110, may instruct microcontroller 122 to turn on or off light source 120, or may instruct imaging sensor 150 to acquire images of the sample.

Apparatus 100 may also include an enclosure 190, as shown in FIG. 3. As with the arrangement of components of apparatus 100, the dimensions of enclosure 190 are selected based on the space or volume requirements of the particular application in which apparatus 100 will be used. In an exemplary embodiment, enclosure 190 has dimensions no longer than about 300 mm on any side. Preferably, enclosure has dimensions no longer than about 200 mm on any side. Even more preferably, enclosure 190 has dimensions of about 200 mm by about 100 mm by about 100 mm.

Enclosure 190 may be hermetically-sealed. This may be preferable for applications in which apparatus 100 is designated for use as a microscope on a satellite or other spacecraft. Suitable structures or materials for hermetically sealing enclosure 190 will be known to one of ordinary skill in the art from the description herein. A hermetic enclosure 190 may be useful in order to change the atmospheric pressure, gas composition, etc., therein, in order to keep samples in a controlled and defined environment. The hermetic enclosure 190 may further include one or more heaters and/or coolers in order to regulate the temp of both the components and the sample.

In an exemplary embodiment, the optical and electronic components of apparatus 100 are assembled on a system of shelves or trays with enclosure 190, as shown in FIG. 18. These shelves may be designed to slide into rails in enclosure 190. Separating the optical and electronic components into layers may facilitate assembly and wiring.

In accordance with aspects of the present invention, systems may be formed including multiple microscope apparatus 100. In an exemplary embodiment, a system may be formed including one or more microscopes of varying types. For example, an exemplary system may include one or more of a fluorescence microscope, a dark field microscope, and/or a chemiluminescent microscope. The selection of light sources and stages for these other microscope types will be known to one of ordinary skill in the art from the description herein.

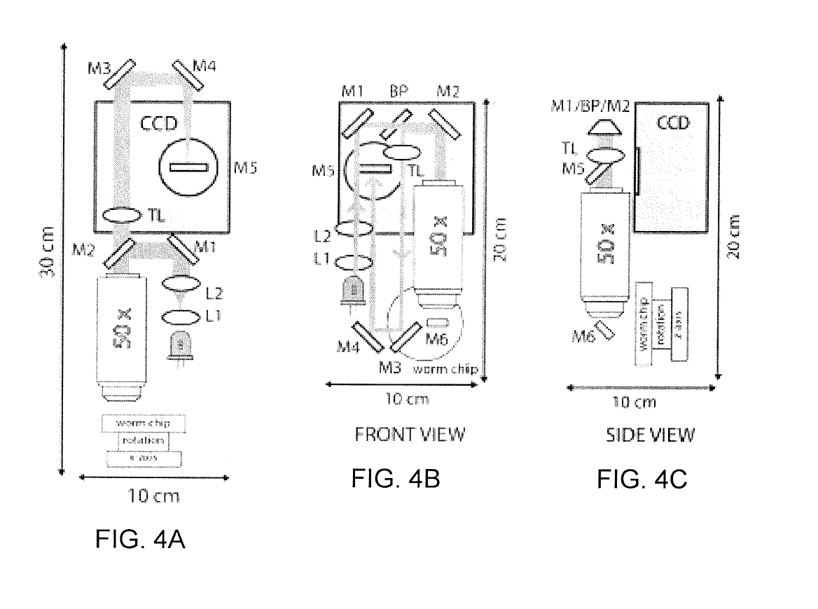

FIGS. 4A-4C show alternative exemplary layouts of the microscope components of apparatus 100. These embodiments may be well-suited for creating a desired travel length of light from the stage to the imaging sensor in order to form an image using the objective, while maintaining a compact arrangement of components. In an exemplary embodiment, a path length of up to 200 mm can be created by two or more beam folding mirrors, as shown in FIGS. 4A-4C. If more space is needed for electronic components of the microscope, then additional mirrors may be used in a 3D configuration to fit the optical components.

FIG. 4A illustrates an optical layout for a 3U CubeSat enclosure, having dimensions of about 300 mm by about 100 mm by about 100 mm. FIGS. 4B and 4C illustrate an optical layout for a 2U CubeSat enclosure, having dimensions of about 200 mm by about 100 mm by about 100 mm. The basic microscope configurations are based on epiillumination. In FIG. 4A, the light source is a blue LED that is collimated by lenses L1 and L2. M1 is a mirror that diverts the light to reflect off a dichroic mirror (M2) and projected onto the back aperture of a 50x air objective. The illumination light is focused onto the sample (in this example, a microfluidic device or “worm chip” housing living microorganisms). The reflected light (or fluorescence) is passed through M2 and focused by a 200 mm tube lens (TL). The focused light is directed by three mirrors (M3, M4, M5) to a CCD camera (gray boxes). A movable bandpass filter can be placed before the CCD to collect only the emitted fluorescence. In FIGS. 4B and 4C, the microscope design is similar to the 2D optical layout from FIG. 4A, except that the illumination and image path is steered in three dimensions to improve space efficiency. FIG. 4B is the front view of the instrument, and FIG. 4C is the side view. M6 is a small mirror that can be used with ultra long working distance objectives (˜20 mm) to further optimize space.

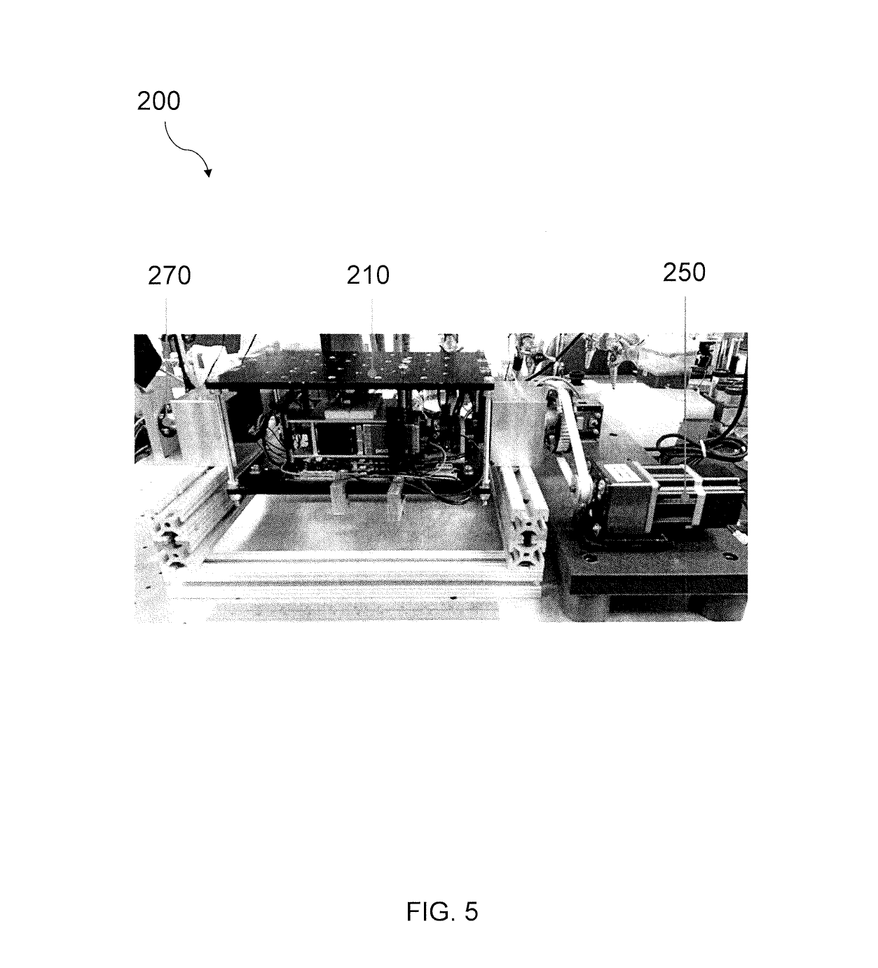

FIG. 5 illustrates another exemplary compact microscope apparatus 200 in accordance with aspects of the present invention. Apparatus 200 may be a fluorescence microscope usable to obtain microscopic images in low gravity or moving environments. Apparatus 200 includes the same components as apparatus 100 except as indicated below.

Apparatus 200 includes a clinostat 250. Clinostat 250 is a device configured to continuously rotate one or more objects (e.g. mounted to a disc) in order to negate the effects of gravity on the objects. In an exemplary embodiment, clinostat 250 includes a frame or disc and a pulley that connects the frame or disc to a motor. This motor is geared to provide stable rotation speeds in the range 1-20 rpm. Suitable motors for use in clinostat 250 include, for example, brushless DC motors provided by www.wondermotor.com.

The stage, light source, objective, dichroic element, and image sensor of apparatus 200 (hereinafter the “microscope components 210”) are coupled to the disc of clinostat 250. As such, clinostat 250 is operable to continuously rotate the microscope components 210 of apparatus 200 about an axis. The axis may be oriented in a direction perpendicular to the focal plane of the stage.

Rotating the microscope components 210 with clinostat 250 may introduce mechanical noise into the imaging system, primarily as a cyclic shift in the image field-of-view. This shift can be caused by slight shifts in the body of the microscope components 210 at different angles relative to the gravitational field. This can be compensated for by either using fiducial markers—for example, by placing sample on micro-ruled coverslips—or by synchronizing the imaging system with the rotating frame.

Clinostat 250 may include its own power source, or may share a power source with the microscope components 210 of apparatus 200. Where clinostat 250 shares a power source with the microscope components 210, or where the microscope components 210 are coupled to an external power supply, apparatus 200 may include one or more electrical slip rings. An electrical slip ring includes a continuous annular electrical contact, which may be contacted by a rotating electrical contact throughout its rotation to maintain electrical contact between the rotating contact and the stationary annular contact. An exemplary slip ring 270 for coupling the microscope components 210 of apparatus 200 to an external power source is shown in FIG. 5. Suitable slip rings for use as slip ring 270 include, for example, those provided by Adafruit Industries, of New York, N.Y.

Clinostat 250 may also include its own computing element, or may share a computing element with the microscope components 210 of apparatus 200. The computing element of clinostat 250 may be operable to provide instructions for turning on and off the rotation of clinostat 250. The computing element may also control a rotational speed of clinostat 250, e.g., through pulse-width modulated control signals.

As with apparatus 100, the microscope components 210 of apparatus 200 may be sized and arranged to be enclosed within an enclosure. The enclosure of apparatus 200 may have the same or different dimensions and features from the enclosure 190 of apparatus 100. In an exemplary embodiment, the enclosure of apparatus 200 may enclose only the microscope components 210. In this embodiment, the enclosure itself may be mounted to the disc of clinostat 250. Alternatively, apparatus 200 may include an enclosure that encloses both the microscope components 210 and clinostat 250.

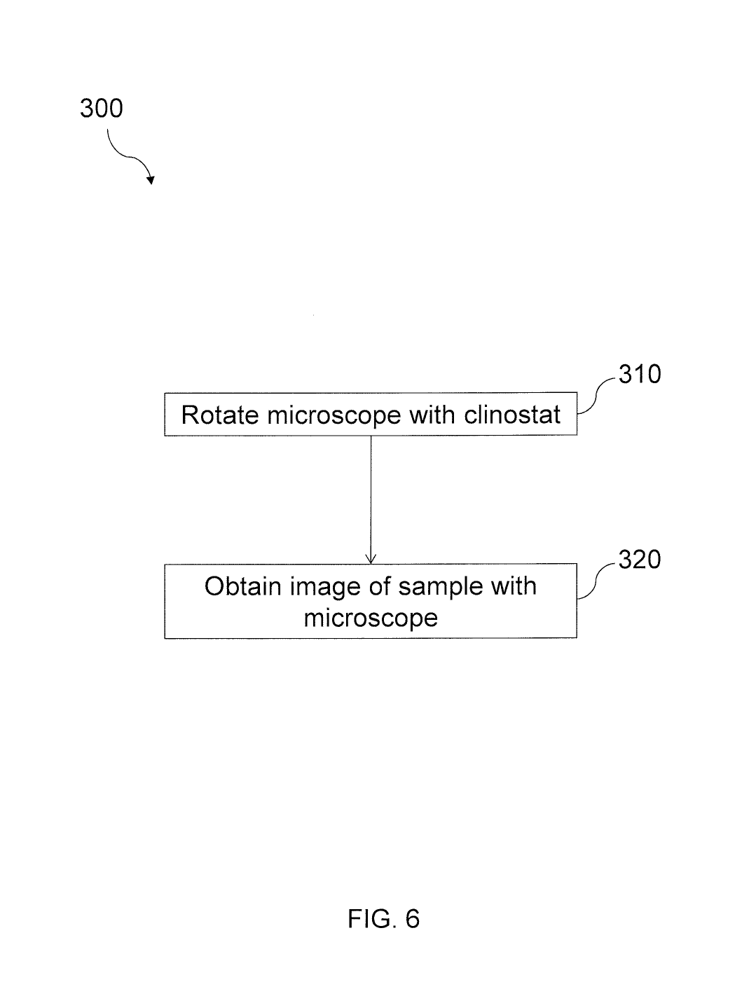

FIG. 6 illustrates an exemplary method 300 for obtaining a microscopic image in accordance with aspects of the present invention. Method 300 may be used to obtain microscopic images in low gravity or moving environments. As a general overview, method 300 includes the steps of rotating a microscope with a clinostat, and obtaining an image of a sample with the rotating microscope. Additional details of method 300 are described below.

In step 310, a microscope is rotated with a clinostat. In an exemplary embodiment, the microscope components 210 of apparatus 200 are rotated using clinostat 250. The microscope components 210 may be continuously rotated over a period of time selected based on a desired length of observation of the sample. Suitable periods of rotation include, for example, 1-20 rpm.

In step 320, an image of a sample is obtained. In an exemplary embodiment, the imaging sensor obtains a microscopic image of a sample on the stage during rotation of the microscope components 210 by clinostat 250. The imaging sensor may continuously obtain images, or may periodically obtain images during rotation.

Method 300 is not limited to the above-described steps, but may include alternate or additional steps, as would be understood by one of ordinary skill in the art from the description herein.

For example, where apparatus 200 includes an enclosure, method 300 may include the step of enclosing the components of apparatus 200 within the enclosure. The microscope components 210 of apparatus 200 may be enclosed, or alternatively, the microscope components 210 and clinostat 250 may be enclosed, depending on the intended use of apparatus 200.

For another example, method 300 may include the step of changing a distance travelled by the light from the stage to the imaging sensor. As set forth above, the stage of the microscope may be movable to change the focal distance of the microscope. By moving the stage, the distance travelled by the light may be changed in order to focus the microscope on the sample to be imaged.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A compact microscope apparatus comprising:
a stage configured to hold a sample thereon;
a light source configured to emit light toward the stage;
an objective positioned to focus light from the stage;
a dichroic element configured to pass one of the light emitted by the light source and the light from the stage and reflect the other one of the light emitted by the light source and the light from the stage; and
an imaging sensor positioned to receive the light from the stage,
wherein the stage, the light source, the objective, the dichroic element, and the imaging sensor are arranged such that they may be received within an enclosure having dimensions no longer than about 300 mm.

2. The compact microscope apparatus of claim 1, further comprising a power supply coupled to provide power to the light source and the imaging sensor.

3. The compact microscope apparatus of claim 2, further comprising a computing element coupled to the imaging sensor, the computing element configured to operate the imaging sensor to obtain images of the sample when the sample is held on the stage.

4. The compact microscope apparatus of claim 3, further comprising a memory device coupled to the imaging sensor, the computing element configured to store the images of the sample in the memory device.

5. The compact microscope apparatus of claim 4, wherein the power supply, the computing element, and the memory device are arranged relative to the stage, the light source, the objective, the dichroic element, and the imaging sensor such that they may all be received within an enclosure having dimensions no longer than about 300 mm.

6. The compact microscope apparatus of claim 1, further comprising the enclosure having dimensions no longer than about 300 mm.

7. The compact microscope apparatus of claim 6, wherein the enclosure is a hermetically-sealed enclosure.

8. The compact microscope apparatus of claim 1, wherein the objective is fixed in position relative to the image sensor, and the stage is movable to change a distance travelled by the light from the stage to the imaging sensor.

9. The compact microscope apparatus of claim 1, wherein the dichroic element passes the light emitted by the light source therethrough and reflects the light from the stage toward the imaging sensor.

10. A compact microscope apparatus comprising:
a stage configured to hold a sample thereon;
a light source configured to emit light toward the stage;
an objective positioned to focus light from the stage;
a dichroic element configured to pass one of the light emitted by the light source and the light from the stage and reflect the other one of the light emitted by the light source and the light from the stage;
an imaging sensor positioned to receive the light from the stage; and
a clinostat to which the stage, the light source, the objective, the dichroic element, and the imaging sensor are attached, the clinostat operable to continuously rotate the stage, the light source, the objective, the dichroic element, and the imaging sensor about an axis.

11. The compact microscope apparatus of claim 10, further comprising a power supply coupled to provide power to the light source and the imaging sensor, the power supply attached to and configured to be rotated by the clinostat.

12. The compact microscope apparatus of claim 11, further comprising a computing element coupled to the imaging sensor, the computing element configured to operate the imaging sensor to obtain images of the sample when the sample is held on the stage, the computing element attached to and configured to be rotated by the clinostat.

13. The compact microscope apparatus of claim 12, further comprising a memory device coupled to the imaging sensor, the computing element configured to store the images of the sample in the memory device, the memory device attached to and configured to be rotated by the clinostat.

14. The compact microscope apparatus of claim 13, wherein the stage, the light source, the objective, the dichroic element, the imaging sensor, the clinostat, the power supply, the computing element, and the memory device are arranged such that they may be received within an enclosure having dimensions no longer than about 300 mm.

15. The compact microscope apparatus of claim 10, further comprising an enclosure having dimensions no longer than about 300 mm, wherein the light source, the objective, the dichroic element, the imaging sensor, and the clinostat are received within the enclosure

16. The compact microscope apparatus of claim 15, wherein the enclosure is a hermetically-sealed enclosure.

17. The compact microscope apparatus of claim 10, wherein the objective is fixed in position relative to the image sensor, and the stage is movable to change a distance travelled by the light from the stage to the imaging sensor.

18. The compact microscope apparatus of claim 10, wherein the dichroic element passes the light emitted by the light source therethrough and reflects the light from the stage toward the imaging sensor.

19. A method for obtaining a microscopic image of a sample, comprising the steps of:
rotating a microscope with a clinostat, the microscope comprising:
a stage on which is held a sample;
a light source configured to emit light toward the stage;
an objective positioned to focus light from the stage;
a dichroic element configured to pass one of the light emitted by the light source and the light from the stage and reflect the other one of the light emitted by the light source and the light from the stage; and
an imaging sensor positioned to receive the light from the stage; and
obtaining an image of the sample with the microscope while the microscope is rotated with the clinostat.

20. The method of claim 19, further comprising the step of enclosing the microscope and the clinostat within an enclosure having dimensions no longer than about 300 mm.

21. The method of claim 19, further comprising the step of moving the stage to change a distance travelled by the light from the stage to the imaging sensor.

22. The method of claim 19, wherein the step of obtaining the image of the sample comprises passing the light emitted by the light source through the dichroic element and reflecting the light from the stage toward the imaging sensor with the dichroic element.
